(19) United States
(12) Patent Application Publication
(10) Pub. No.: US 2025/0271732 A1
(43) Pub. Date: Aug. 28, 2025

(54) IMAGE DISPLAY DEVICE AND SMARTPHONE

(71) Applicant: NICHIA CORPORATION, Anan-shi (JP)

(72) Inventor: Kazuhiro KAMADA, Tokushima-shi (JP)

(73) Assignee: NICHIA CORPORATION, Anan-shi (JP)

(21) Appl. No.: 19/062,704

(22) Filed: Feb. 25, 2025

(30) Foreign Application Priority Data
Feb. 28, 2024 (JP) 2024-028837

(51) Int. Cl. G03B 15/03; G02B 3/08; H04M 1/02; H04M 1/22

(52) U.S. Cl. CPC G03B 15/03; H04M 1/0266; H04M 1/22; G02B 3/08; G03B 2215/0567; G03B 2215/0592; H04M 2250/52

(57) ABSTRACT

An image display device includes: a housing including an inner surface defining an opening, and an outer surface located on a side opposite to the inner surface; a display unit including a display surface and disposed in the opening and; and a structure including a light-emitting surface, the structure at least partially protruding from the outer surface when viewed facing the display surface. The structure includes: a light-transmissive member including an emission surface and an incident surface, the emission surface at least partially constituting the light-emitting surface, and a light source unit that is configured to emit light to the incident surface of the light-transmissive member and through the light-transmissive member in a direction in which the display surface faces.

### CROSS-REFERENCE TO RELATED APPLICATION

This application claims priority to Japanese Patent Application No.2024-028837, filed on Feb. 28, 2024, the disclosure of which is hereby incorporated by reference in its entirety.

### TECHNICAL FIELD

The present disclosure relates to an image display device and a smartphone.

### BACKGROUND

For example, Japanese Patent Publication No. 2021-520171 discloses an image display device including a light source unit disposed on a movable sheet that can extend from a mobile terminal.

### SUMMARY

An object of an embodiment according to the present disclosure is to provide an image display device that can irradiate a subject when performing imaging from a display side.

An image display device according to an embodiment of the present disclosure includes a housing including an inner surface defining an opening, and an outer surface located on a side opposite to the inner surface; a display unit including a display surface and disposed in the opening and; and a structure including a light-emitting surface, the structure at least partially protruding from the outer surface when viewed facing the display surface, wherein the structure comprises: a light-transmissive member including an emission surface and an incident surface, the emission surface at least partially constituting the light-emitting surface, and a light source unit that is configured to emit light to the incident surface of the light-transmissive member and through the light-transmissive member in a direction in which the display surface faces.

According to embodiments of the present disclosure, an image display device in which a light source unit can be disposed in an existing portion can be provided.

### BRIEF DESCRIPTION OF THE DRAWINGS

FIG. 1 is a schematic view of a smartphone including an image display device according to an embodiment when viewed facing a display surface.

FIG. 2 is a schematic view of a structure included in the image display device according to the embodiment when viewed facing the display surface.

FIG. 3 is a schematic view of the structure included in the image display device according to the embodiment when viewed from a −X side.

FIG. 4 is a schematic view of the structure included in the image display device according to the embodiment when viewed from a +X side.

FIG. 5 is a schematic cross-sectional view taken along line V-V in FIG. 2.

FIG. 6 is a schematic cross-sectional view illustrating a light-emitting unit included in a light source unit of the image display device according to the embodiment.

FIG. 7 is a schematic view of a structure included in an image display device according to an aspect of a first modified example when viewed facing the display surface.

FIG. 8 is a schematic view of the structure included in the image display device according to the aspect of the first modified example when viewed from the −X side.

FIG. 9A is a schematic cross-sectional view taken along line IX-IX in FIG. 7 and is a schematic view illustrating a cross section passing through a first lateral portion, a second lateral portion, and a center of a light-transmissive member.

FIG. 9B is a schematic view of a structure included in the image display device according to an aspect of the first modified example when viewed facing the display surface.

FIG. 10 is a schematic cross-sectional view of a structure included in an image display device according to a second modified example.

FIG. 11 is a schematic cross-sectional view of a structure included in an image display device according to a third modified example.

FIG. 12 is a schematic view of a structure included in an image display device according to a fourth modified example when viewed facing the display surface.

FIG. 13 is a schematic cross-sectional view taken along line XIII-XIII in FIG. 12.

FIG. 14 is a schematic view of a structure included in an image display device according to a fifth modified example when viewed facing the display surface.

FIG. 15 is a schematic cross-sectional view taken along line XV-XV in FIG. 14.

FIG. 16 is a schematic view of a structure included in an image display device according to a sixth modified example when viewed facing the display surface.

FIG. 17 is a schematic view of the structure included in the image display device according to the sixth modified example when viewed from the −X side.

### DETAILED DESCRIPTION

An image display device and a smartphone according to embodiments of the present disclosure will be described in detail with reference to the drawings. The following embodiments exemplify an image display device and a smartphone for embodying the technical concept of the present embodiment, but the present embodiment is not limited to the following embodiments. Further, dimensions, materials, shapes, relative arrangements, or the like of constituent members described in the embodiments are not intended to limit the scope of the present disclosure thereto, unless otherwise specified, and are merely exemplary. Note that the sizes, positional relationship, or the like of members illustrated in each of the drawings may be exaggerated for clarity of description. Further, in the following description, members having the same terms and reference characters represent the same or similar members, and a detailed description of these members will be omitted as appropriate. As a cross-sectional view, an end view illustrating only a cut surface may be used.

In the following drawings, directions may be indicated by an X axis, a Y axis, and a Z axis. The X axis, the Y axis, and the Z axis are orthogonal to one another. An X direction along the X axis and a Y direction along the Y axis indicate directions along a display surface of a display unit included in the image display device according to the embodiment. AZ direction along the Z-axis indicates a direction orthogonal to the above-mentioned light-emitting surface. In other words, the light-emitting surface of the light-emitting unit is parallel to an XY plane, and the Z-axis is orthogonal to the XY plane.

The direction in the X direction in which an arrow points is referred to as a +X direction or a +X side and the direction opposite to the +X direction is referred to as a −X direction or a −X side. The direction in the Y direction in which an arrow points is referred to as a +Y direction or a +Y side and the direction opposite to the +Y direction is referred to as a −Y direction or a −Y side. The direction in the Z direction in which the arrow faces is the +Z direction or the +Z side and the direction opposite to the +Z direction is the −Z direction or the −Z side. In the embodiments, the light-emitting unit of the image display device emits light toward the +Z direction as an example. In the embodiments, the term “top view” means that a target object is viewed from the display surface side of the display unit included in the image display device according to the embodiments. In the present specification, the term “top view” may be used for a portion that is directly visible from above, and, in addition, also used for a portion that is not directly visible from above to describe the portion as if it were being seen through other portions. However, this does not limit the orientation of the image display device and the smartphone according to the embodiments during use, and the orientation of the image display device and the smartphone according to the embodiments may be any chosen orientation.

For convenience of description, in the present specification, a surface of the target object when viewed from the +Z side is referred to as an “upper surface,” and a surface of the target object when viewed from the −Z side is referred to as a “lower surface.” In addition, the +Z side of the target object may be referred to as an “upper side” and the −Z side of the target object may be referred to as a “lower side.” In the following embodiments, “being aligned with the X-axis, the Y-axis, or the Z-axis” includes the case in which an object has an inclination within a range of ±10° relative to the corresponding axis. In the embodiments, the orthogonality may include a tolerance within ±10° with respect to 90°.

In the present specification or appended claims, when there are a plurality of constituent components and it is desired to denote those components individually, the components may be distinguished by adding terms such as “first,” “second,” and the like in front of terms of the components. Objects to be distinguished may differ between the present specification and the claims. Thus, even when a component in the claims is given the same term as that in the present specification, the object identified by that component is not the same across the present specification and the claims in some cases.

For example, in the present specification, there are components distinguished by being appended with “first,” “second,” and “third,” and in the present specification, when components appended with “first” and “third” are described in the claims, or when components appended with “first” and components not appended with specific ordinal numbers are described in the claims, the components may be distinguished by being appended with “first” and “second” in the claims from the viewpoint of visibility. In this case, in the claims, components denoted by “first,” and “second” respectively indicate components denoted by “first,” and “third,” or components not denoted by specific ordinal numbers in the present specification. This rule applies to not only components but also other objects in a reasonable and flexible manner.

### Embodiment

### Configuration Example of Image Display Device According to Embodiment

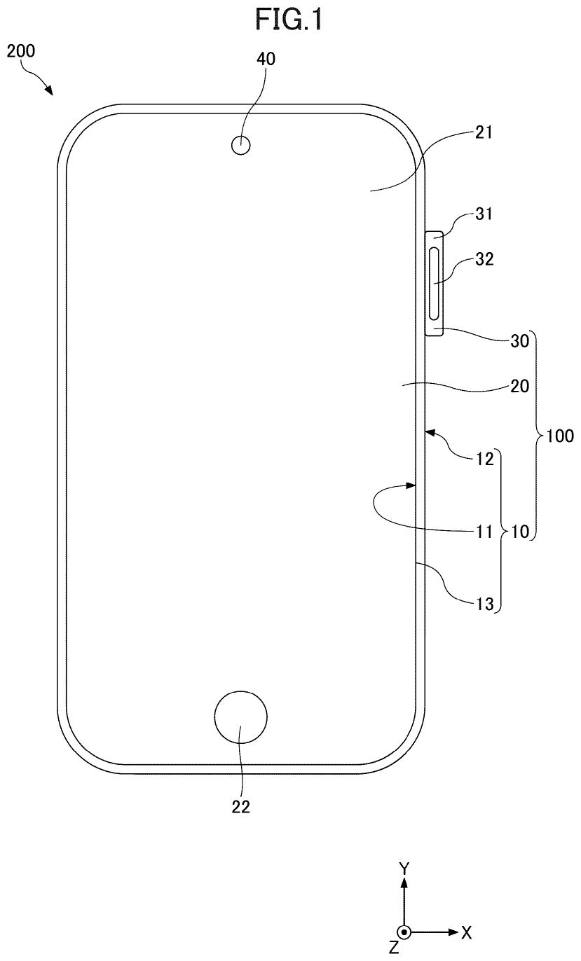

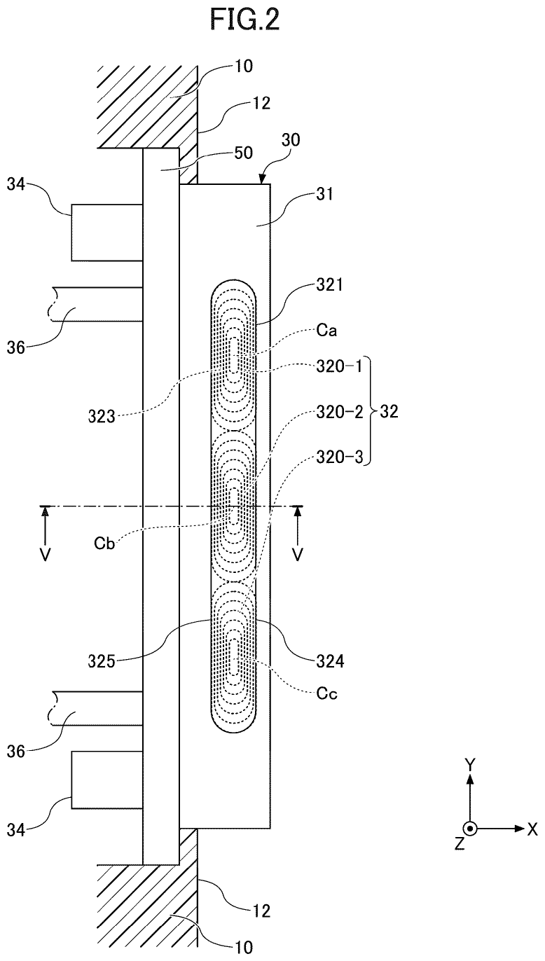

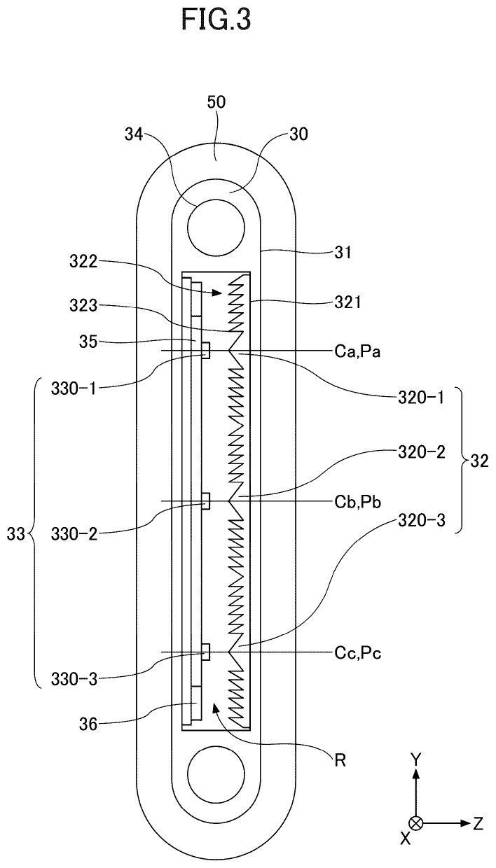

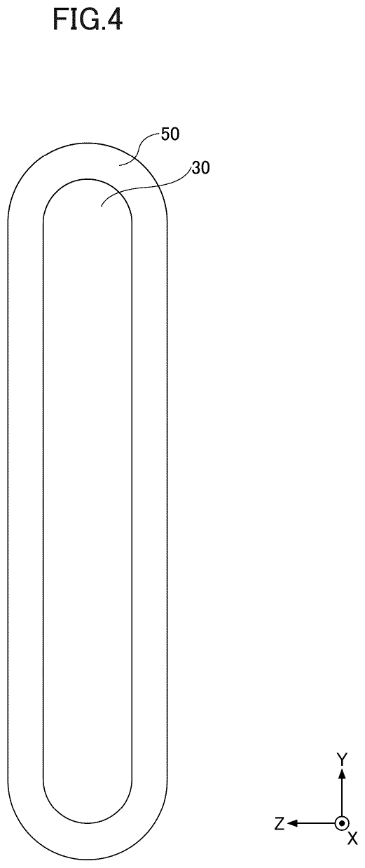

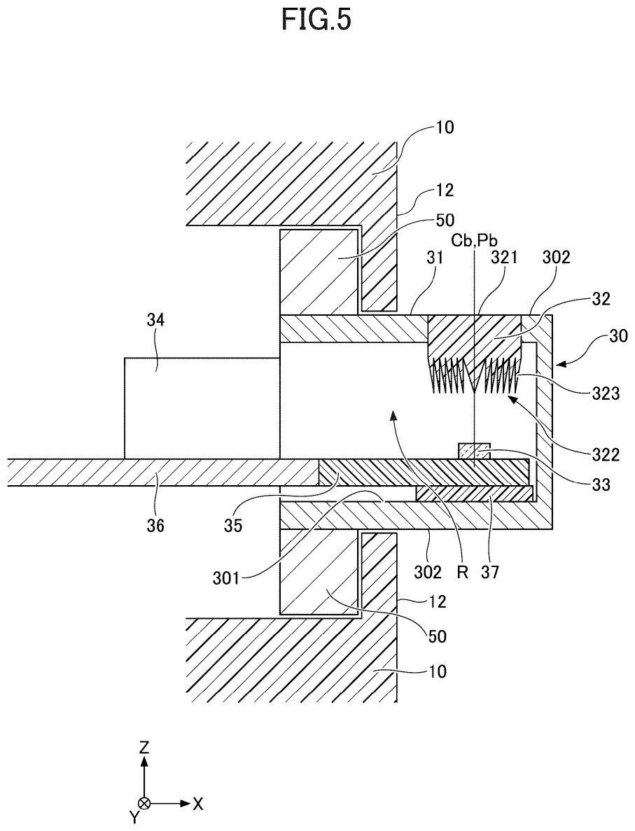

A configuration of the image display device according to the embodiment will be described with reference to FIGS. 1 to 5. FIG. 1 is a schematic view of a smartphone 200 including the image display device according to the embodiment when viewed facing a display surface 21. FIG. 2 is a schematic view of a structure 30 included in the image display device according to the embodiment when viewed facing the display surface 21. FIG. 3 is a schematic view of the structure 30 included in the image display device according to the embodiment when viewed from the −X side (in other words, viewed from the side where the display unit 20 is located). FIG. 4 is a schematic view of the structure 30 included in the image display device according to the embodiment when viewed from the +X side (in other words, viewed from the side opposite to the side where the display unit 20 is located). FIG. 4 omits a housing 10. FIG. 5 is a schematic cross-sectional view taken along line V-V in FIG. 2.

### Overall Configuration

As illustrated in FIG. 1, the smartphone 200 includes an image display device 100. In the example illustrated in FIG. 1, the smartphone 200 includes an imaging device 40.

As illustrated in FIGS. 1 to 5, the image display device 100 includes the housing 10 including an inner surface 11, an outer surface 12 located on the side opposite to the inner surface 11, and an opening 13 defined by the inner surface 11. The image display device 100 includes the display unit 20 disposed in the opening 13 and including the display surface 21, and the structure 30. The structure 30 includes a light-emitting surface 31 and at least partially protrudes from the outer surface 12 when viewed facing the display surface 21. The structure 30 includes a light-transmissive member 32 and a light source unit 33. The light-transmissive member 32 includes an emission surface 321 and an incident surface(s) 322, the emission surface 321 being disposed on the light-emitting surface 31. The light source unit 33 emits light to the incident surface(s) 322 of the light-transmissive member 32, and can emit light through the light-transmissive member 32 in a direction in which the display surface 21 faces.

The housing 10 is a box-shaped member that accommodates the image display device 100, a control board of the image display device 100, and the like inside the housing 10. Examples of a material of the housing 10 that can be used include a resin material and a metal material. In the example illustrated in FIG. 1, the housing 10 has a substantially rectangular shape including long sides and short sides with corner portions being chamfered in a top view. That is, the image display device 100 includes four outer surfaces 12 including two long sides and two short sides, and four inner surfaces 11 including two long sides and two short sides. The size, shape, or the like of the housing 10 can be changed as appropriate in accordance with specifications required for the smartphone 200.

The display unit 20 includes an organic electroluminescence (EL) panel, a liquid crystal panel, or the like. In the example illustrated in FIG. 1, the display unit 20 has a shape similar to that of the housing 10, and has a substantially rectangular shape including long sides and short sides with corner portions being chamfered in a top view. The size, shape, or the like of the display unit 20 can be changed as appropriate in accordance with specifications required for the smartphone 200. In the example illustrated in FIG. 1, the display unit 20 has a touch panel function on the display surface 21. A imaging button 22 in FIG. 1 is an image displayed on the display surface 21. The imaging button 22 is a user interface (UI) that functions as a button for causing the imaging device to perform imaging when a touch operation is performed.

The imaging device 40 is disposed on the display surface 21 of the display unit 20, and an operator of the smartphone 200 shoots himself/herself or a plurality of persons including himself/herself. The imaging device 40 can also be referred to as an imaging device for a selfie. The imaging device 40 is used for video calling, video recording, personal authentication, and the like, using the smartphone 200.

The imaging device 40 can perform imaging by the touch operation of the imaging button 22 by the operator of the smartphone 200. For example, when the operator operates the image display device 100 and the smartphone 200 in order to take a selfie by the imaging device 40, the display surface 21 faces the operator. The operator can shoot himself/herself or a plurality of persons including himself/herself by the imaging device 40 by performing a touch operation on the imaging button 22 while visually recognizing the image of himself/herself or the plurality of persons including himself/herself displayed on the display unit 20.

Here, for example, in the smartphone, there is a case in which a light source unit for lighting cannot be disposed on a side where an imaging device for a selfie is disposed due to restrictions such as an arrangement space. In a smartphone that does not include the light source unit for lighting, lighting cannot be used at the time of imaging for video calling, video recording, personal authentication, and the like. Thus, when the surroundings of the operator are dark, there is a possibility that a high-quality image cannot be obtained. In this specification, the term “image” means an image obtained by video recording and still image capturing.

In a smartphone that does not include the light-emitting unit for lighting on a side where the imaging device for a selfie is disposed in the smartphone, a screen light may be used as a flash of lighting when imaging a still image by the imaging device for a selfie. The screen light refers to white light radiated from the entire display surface of the display unit by displaying a pure white image on the display surface for several seconds. The display surface in this case functions as a surface light source that illuminates the operator who takes a selfie. In a case in which the display surface is caused to function as the screen light, the display surface becomes a pure white image, and thus the operator cannot visually recognize the image being shot during imaging. Thus, in the smartphone, the screen light cannot be used for the selfie video recording by the imaging device, and there is a possibility that a high-quality moving image cannot be obtained in an environment in which the surroundings of the smartphone or the operator are dark. In addition, at the time of imaging of the moving image, in an environment in which the operator cannot visually recognize the image being captured during the imaging, there is a possibility that the imaging of the moving image is difficult.

The image display device 100 according to the present embodiment includes the structure 30 that includes the light-emitting surface 31 and at least partially protrudes from the outer surface 12 when viewed facing the display surface 21. The light source unit 33 included in the structure 30 emits light to the incident surface(s) 322 of the light-transmissive member 32 and can emit light through the light-transmissive member 32 in the direction in which the display surface 21 faces. Thus, according to the present embodiment, the image display device 100 is provided in which the light source unit 33 can be disposed in an existing portion such as an operation button. In addition, according to the present embodiment, the smartphone 200 can be provided including the image display device 100 in which the light source unit 33 can be disposed in the existing portion.

The image display device 100 uses light emitted from the light source unit 33 in the direction in which the display surface 21 faces as lighting in imaging including a still image and a moving image by the imaging device 40 for a selfie, and can obtain a high-quality image even when the surroundings of the smartphone 200 or the operator are dark. The image display device 100 can display an image being captured on the display surface 21 even during imaging of a moving image, allowing the operator to visually recognize the image in imaging of the moving image. Accordingly, the operator easily shoots a moving image. In the image display device 100, there is a possibility that a further high-quality still image can be obtained due to the presence of the auxiliary light from the light-emitting unit even when the surroundings are dark, and the light emitted from the light source unit 33 in the direction in which the display surface 21 faces can be used as a flash in imaging a still image by the imaging device 40 for a selfie.

In the image display device 100 illustrated in FIGS. 1 to 5, the structure 30 is included in the operation button, of the image display device 100, provided on one long side of the outer surface 12 of the housing 10. More specifically, the operation button including the structure 30 is a power button of the image display device 100. In the image display device 100, because the operation button includes the structure 30, the structure 30 does not have to be provided as a member separate from the operation button, and thus the configuration of the image display device 100 can be simplified. The operation button is not limited to the power button of the image display device 100 and may be a button for adjusting the volume of sound or the like in the image display device 100. The operation button of the image display device 100 may be used as a button for operating the smartphone 200. The structure 30 is not limited to the operation button of the image display device 100 as long as the structure 30 is included in the existing portion of the image display device 100 and includes a portion of which at least a part protrudes from the outer surface 12 when viewed facing the display surface 21. For example, the structure 30 may be disposed in an outlet of a power cable of which at least a part protrudes from the outer surface 12. The structure 30 may be disposed in a portion protruding from the outer surface 12 in order to improve the design or the functionality such as ease of holding of the image display device 100. The structure 30 is preferably provided at a position close to the imaging device 40. For example, the structure 30 is preferably disposed on a side close to the imaging device 40 in the housing 10 (for example, on the +Y side when the housing 10 is divided into halves in the Y direction in FIG. 1). When the structure 30 is provided at a position close to the imaging device 40, the possibility of generation of an unintended shadow in a moving image or a still image can be reduced.

### Configuration of Structure 30

The configuration of the structure 30 will be described in detail with reference to FIGS. 2 to 5.

The structure 30 illustrated in FIGS. 2 and 5 is part of the operation button disposed in the housing 10. Part of the operation button is located inside the housing 10, and part of the operation button protruding from the outer surface 12 of the housing 10 includes the structure 30. The structure 30 can be moved in a direction (for example, the X direction) orthogonal to the direction in which the display surface 21 faces by an operation of pressing the structure 30. In the present embodiment, the structure 30 does not indicate only a portion protruding from the outer surface 12. For example, the structure 30 includes a portion that is moved by an operation of pushing the structure 30 and is accommodated inside the housing 10 from the outside of the outer surface 12, and a portion that supports the light-transmissive member 32 and the light source unit 33 and is accommodated inside the housing 10 before the structure 30 is pushed. In the present embodiment, in the portion that is moved by the operation of pushing the structure 30 and is accommodated inside the housing 10 from the outside of the outer surface 12 and the portion that supports the light-transmissive member 32 and the light source unit 33 and is accommodated inside the housing 10 before the structure 30 is pushed, one portion may have the function of the other portion.

The operation button in the present embodiment includes the structure 30, a flange portion 50, and a support portion 34. The structure 30 includes an inner surface 301 and an outer surface 302 located on the side opposite to the inner surface 301. The flange portion 50 is disposed on the −X side of the outer surface 302 of the structure 30 and inside the housing 10. The support portion 34 is a portion that is disposed with and supports the structure 30 in the housing 10, and is disposed on the side opposite to the outer surface 302 of the structure 30 that is pressed by the pressing operation and is inside the housing 10. The structure 30 illustrated in FIG. 2 has a substantially rectangular shape including long sides and short sides in a top view. The structure 30 illustrated in FIGS. 2 and 5 has a through hole in the light-emitting surface 31, and the light-transmissive member 32 is disposed inside the through hole. The structure 30 has a space R surrounded by the inner surface 301 of the structure 30 and the incident surface(s) 322 of the light-transmissive member 32. The structure 30 includes a substrate 35 on which the light source unit 33 is disposed. The substrate 35 is disposed inside the structure 30 and is fixed to the inner surface 301 of the structure 30 by an adhesive member 37. The light source unit 33 is disposed on a surface of the substrate 35 disposed inside the structure 30, this surface facing the light-transmissive member 32 (for example, a surface on the +Z side). The light source unit 33 can emit light in a direction in which the light-transmissive member 32 is located. A wiring 36 is electrically connected to the substrate 35.

In the present embodiment, the structure 30, the flange portion 50, and the support portion 34 are monolithically formed of a resin material. For example, a polypropylene resin, a polystyrene resin, a polyethylene resin, an acrylic resin, a polycarbonate resin, an acrylonitrile-styrene (AS) resin, or an acrylonitrile-butadiene-styrene (ABS) resin can be used as a base material for the structure 30, the flange portion 50, and the support portion 34, and the base material may contain a light reflective substance or a light absorbing substance. The structure 30, the flange portion 50, and the support portion 34 may be monolithically formed of a metal material. The metal material is, for example, aluminum, titanium, or stainless steel. The structure 30, the flange portion 50, and the support portion 34 may be formed of different materials.

For the substrate 35, an insulating material is preferably used as a base material, and a material through which the light emitted from the light source 33, external light, and the like are not readily transmitted is preferably used. Further, for the substrate 35, a material having a certain degree of strength is preferably used. Specifically, the substrate 35 can be formed of a ceramic, such as alumina, aluminum nitride, mullite, or silicon nitride, or a resin, such as a phenol resin, an epoxy resin, a polyimide resin, a bismaleimide triazine resin (BT resin), a polyphthalamide resin, a polyester resin, or the like, as the base material. From the viewpoint of improving heat dissipation properties, the substrate 35 preferably contains copper. For example, a flexible printed circuit (FPC) can be employed as the substrate 35.

In the examples illustrated in FIGS. 2 to 5, the light-transmissive member 32 is a lens. Employing the lens for the light-transmissive member 32 enables the image display device 100 to control a distribution of the light emitted from the light source unit 33. Controlling the distribution of the light emitted from the light source unit 33 enables the image display device 100 to radiate light suitable for the environment in which the image is captured by the imaging device. The imaging device can obtain a high-quality shot image.

In the example illustrated in FIGS. 2 to 5, the lens in the light-transmissive member 32 includes a plurality of protrusions 323 each having a concentric elliptical shape on the incident surface(s) 322 side. For example, the plurality of protrusions 323 have a Fresnel shape, and the lens in the light-transmissive member 32 is a Fresnel lens. When the lens in the light-transmissive member 32 includes the plurality of protrusions 323 each having the concentric elliptical shape on the incident surface(s) 322 side, the lens in the light-transmissive member 32 can be made thin in the image display device 100. In the present embodiment, an upper surface of the lens in the light-transmissive member 32 is flat. Accordingly, protrusions and recessions of the surface of the structure 30 when the lens is disposed can be reduced. As a result, the image display device 100 and the smartphone 200 can improve an aesthetic appearance and improve functionality such as the ease of holding and the case of pushing the structure 30. The plurality of protrusions 323 each may have a concentric circular shape and are not limited to the concentric elliptical shape. In a top view, an outer shape of the light-transmissive member 32 is preferably similar to the shape of the structure 30. For example, when the structure 30 has a substantially rectangular shape in a top view, the outer shape of the light-transmissive member 32 also preferably has a shape including long sides such as a rectangular shape. Accordingly, a ratio of an area of the light-transmissive member 32 to an area of the structure 30 in a top view can be secured to be large and an amount of light emitted from the emission surface 321 of the light-transmissive member 32 can be increased.

The light-transmissive member 32 illustrated in FIG. 2 includes a first lateral portion 324 and a second lateral portion 325 that is parallel to and equal in length to the first lateral portion 324. In a top view (when viewed facing the display surface 21), the outer shape of the light-transmissive member 32 is a shape whose longitudinal direction is a direction along the first lateral portion 324, and is a substantially elliptical shape. In a top view, both ends of the first lateral portion 324 and the second lateral portion 325 have an arc-shaped curve connecting one end of the first lateral portion 324 and one end of the second lateral portion 325 to each other and an arc-shaped curve connecting the other end of the first lateral portion 324 and the other end of the second lateral portion 325 to each other, respectively. The light-transmissive member 32 has a shape whose longitudinal direction is the direction along the first lateral portion 324 when viewed facing the display surface 21, Thus, the light-transmissive member 32 can transmit light from the light source unit 33 including a plurality of the light-emitting units disposed in the direction along the first lateral portion 324 and emit the light in the direction in which the display surface 21 faces. When viewed facing the display surface 21, both ends of the first lateral portion 324 and the second lateral portion 325 have curves, and thus the light-transmissive member 32 can reduce vignetting of light from the light source unit 33, efficiently transmit the light from the light source unit 33, and emit the light in the direction in which the display surface 21 faces. However, the shape of the light-transmissive member 32 when viewed facing the display surface 21 is not limited to that described above, and can be appropriately changed depending on the shape of the structure 30 or the like. The lens in the light-transmissive member 32 may be other forms, such as a biconvex single lens, a planoconvex single lens, a biconcave single lens, a planoconcave single lens, an array lens, a meniscus single lens, an aspherical lens, or a cylindrical lens.

The light source unit 33 illustrated in FIGS. 2 to 5 includes the plurality of light-emitting units including a light-emitting unit 330-1, a light-emitting unit 330-2, and a light-emitting unit 330-3. The light-emitting unit 330-1, the light-emitting unit 330-2, and the light-emitting unit 330-3 are arranged side by side in the direction along the first lateral portion 324. The lens in the light-transmissive member 32 includes a plurality of lens units including a lens unit 320-1, a lens unit 320-2, and a lens unit 320-3 corresponding to the light-emitting unit 330-1, the light-emitting unit 330-2, and the light-emitting unit 330-3, respectively. The lens unit 320-1 mainly transmits light from the light-emitting unit 330-1. The lens unit 320-2 mainly transmits light from the light-emitting unit 330-2. The lens unit 320-3 mainly transmits light from the light-emitting unit 330-3. Each of the light transmitted through a respective one of the lens unit 320-1, the lens unit 320-2, and the lens unit 320-3 is emitted in the direction in which the display surface 21 faces. In the examples illustrated in FIGS. 3 and 5, an optical axis of each lens unit is disposed so as to overlap a center of a corresponding light-emitting unit in a top view. That is, an optical axis Ca of the lens unit 320-1 overlaps a center Pa of the light-emitting unit 330-1. An optical axis Cb of the lens unit 320-2 overlaps a center Pb of the light-emitting unit 330-2. An optical axis Cc of the lens unit 320-3 overlaps a center Pc of the light-emitting unit 330-3. In the image display device 100, the light from the plurality of light-emitting units in the light source unit 33 is emitted through the corresponding lenses, so that the light distribution of the light emitted from each light-emitting unit can be controlled to increase an amount of the light emitted from the light-transmissive member 32. Accordingly, the imaging device can capture using bright radiation light and obtain a high-quality shot image.

The light-transmissive member 32 includes at least one of a resin material, such as a polycarbonate resin, an acrylic resin, a silicone resin, an epoxy resin, or the like, or a glass material, which have transmissivity to the light emitted from the light source unit 33.

When both the structure 30 and the light-transmissive member 32 are formed of a resin material, the light-transmissive member 32 can be formed monolithically with the structure 30 by, for example, a two-color molding method. On the other hand, when the structure 30 is formed of the metal material and the light-transmissive member 32 is formed of the resin material or the glass material, the light-transmissive member 32 is disposed inside an opening provided in the light-emitting surface 31 of the structure 30 when viewed facing the display surface 21, and is fixed to the structure 30 by an adhesive member or the like. Alternatively, the light-transmissive member 32 may be fixed so as to firmly fit inside the opening provided in the light-emitting surface 31 of the structure 30. Accordingly, the emission surface 321 of the light-transmissive member 32 partially constitutes the light-emitting surface 31 of the structure 30.

### Configuration of Light-emitting Unit 330-1

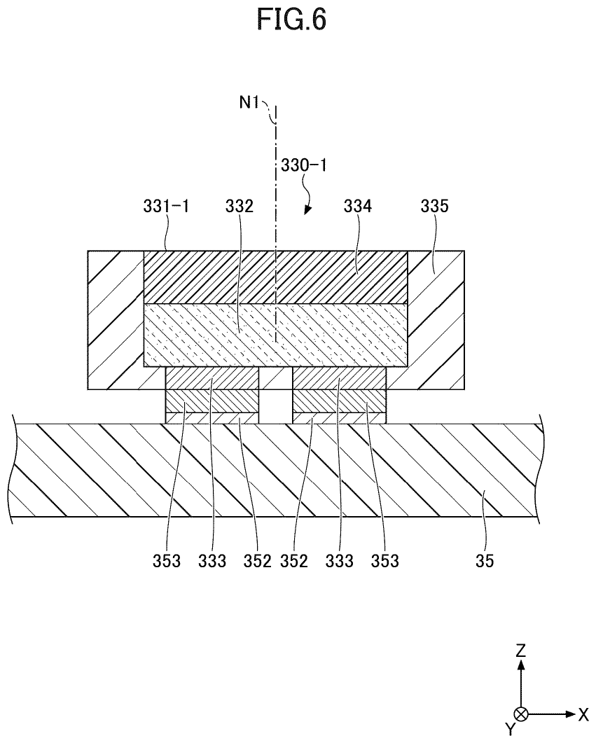

The light-emitting unit 330-1 included in the light source unit 33 will be described in detail with reference to FIG. 6. FIG. 6 is a schematic cross-sectional view of the light-emitting unit 330-1 included in the light source unit 33 of the image display device 100, including a normal line N1 of the light-emitting surface 331-1. In the present embodiment, the light-emitting unit 330-1, the light-emitting unit 330-2, and the light-emitting unit 330-3 included in the light source unit 33 have substantially the same configuration. Here, the light-emitting unit 330-1 will be described as representative. The light-emitting unit 330-1, the light-emitting unit 330-2, and the light-emitting unit 330-3 included in the light source unit 33 may be partially different from each other in configuration.

In the example illustrated in FIG. 6, the light-emitting unit 330-1 includes a light-emitting element 332, a wavelength conversion member 334 provided on the light-emitting element 332, and a covering member 335 covering a lateral surface of the light-emitting element 332 and a lateral surface of the wavelength conversion member 334. With this configuration, the light-emitting unit 330-1 can emit mixed light of the light from the light-emitting element 332 and light subjected to wavelength conversion by the wavelength conversion member 334. In the light-emitting unit 330-1, a degree of freedom of a color of light emitted from the light-emitting unit 330-1 can be increased by a combination of the light-emitting element 332 and the wavelength conversion member 334. When the light-emitting unit 330-1 includes the covering member 335, light leaking from the light-emitting unit 330-1 and the covering member 335 can be reduced, and light extraction efficiency of the light-emitting unit 330-1 can be increased.

In the example illustrated in FIG. 6, the light-emitting unit 330-1 includes at least a pair of positive and negative electrodes 333 on a surface (that is, a lower surface) on the side opposite to the light-emitting surface 331-1 of the light-emitting element 332.

The light-emitting element 332 includes various semiconductors such as a III-V compound semiconductor or a II-VI compound semiconductor. As the semiconductor, preferably, a nitride-based semiconductor such as In_{X}Al_{Y}Ga_{1-X-Y}N (0≤X, 0≤Y, X+Y≤1) or the like is used, and InN, AlN, GaN, InGaN, AlGaN, InGaAlN, and the like can also be used. The light-emitting element 332 is a light-emitting diode (LED) or a laser diode (LD), for example. A light emission peak wavelength of the light-emitting element 332 is preferably in a range from 400 nm to 530 nm, more preferably in a range from 420 nm to 490 nm, even more preferably in a range from 450 nm to 475 nm from the viewpoint of light emission efficiency, excitation of a wavelength conversion substance, and the like.

The wavelength conversion member 334 is, for example, a member having a substantially rectangular shape in a top view. The wavelength conversion member 334 is provided so as to cover an upper surface of the light-emitting element 332. The wavelength conversion member 334 contains a wavelength conversion substance that converts a wavelength of at least part of light from the light-emitting element 332. The wavelength conversion member 334 can be formed using a light-transmissive resin material or an inorganic material such as ceramic or glass. As the resin material, a thermosetting resin, such as a silicone resin, a silicone modified resin, an epoxy resin, an epoxy modified resin, or a phenol resin, can be used. Particularly, a silicone resin or a modified resin thereof with good light resistance and heat resistance is used. Note that herein, light transmissivity is preferably a property in which 60% or more of the light from the light-emitting element 332 is transmitted. Further, as the wavelength conversion member 334, a thermoplastic resin, such as a polycarbonate resin, an acrylic resin, a methyl pentene resin, or a polynorbornene resin, can be used. The wavelength conversion member 334 may contain a light reflective substance described below in the resin described above. The wavelength conversion member 334 may be, for example, a member containing a wavelength conversion substance in the resin material, ceramic, glass, or the like, and a sintered body of a wavelength conversion substance. The wavelength conversion member 334 may be a multi-layered member formed by disposing a resin layer on the surfaces on the ±Z side of a formed body, of the resin, ceramic, glass, or the like.

Examples of the wavelength conversion substance included in the wavelength conversion member 334 include an yttrium aluminum garnet-based phosphor (for example, (Y, Gd)₃(Al, Ga)₅O₁₂:Ce), a lutetium aluminum garnet-based phosphor (for example, Lu₃(Al, Ga)₅O₁₂:Ce), a terbium aluminum garnet-based phosphor (for example, Tb₃(Al, Ga)₅O₁₂:Ce), a CCA-based phosphor (for example, Ca₁₀(PO₄)₆Cl₂: Eu), an SAE-based phosphor (for example, Sr₄Al₁₄O₂₅Eu), a chlorosilicate-based phosphor (for example, Ca₈MgSi₄O₁₆Cl₂:Eu), a silicate-based phosphor (for example, (Ba, Sr, Ca, Mg)₂SiO₄:Eu), oxynitride-based phosphors, such as a β-SiAlON-based phosphor (for example, (Si, Al)₃(O,N)₄:Eu) and an α-SiAlON-based phosphor (for example, Ca(Si, Al)₁₂(O,N)₁₆:Eu), nitride-based phosphors, such as an LSN-based phosphor (for example, (La, Y)₃Si₆N₁₁:Ce), a BSESN-based phosphor (for example, (Ba, Sr)₂Si₅N₈:Eu), an SLA-based phosphor (for example, SrLiAl₃N₄:Eu), a CASN-based phosphor (for example, CaAlSiN₃:Eu), and an SCASN-based phosphor (for example, (Sr, Ca)AlSiN₃:Eu), fluoride-based phosphors, such as a KSF-based phosphor (for example, K₂SiF₆:Mn), a KSAF-based phosphor (for example, K₂(Si₁₋ₓAlₓ)F₆₋ₓ:Mn, where x satisfies 0<x<1), and an MGF-based phosphor (for example, 3.5 MgO·0.5 MgF₂·GeO₂:Mn), a quantum dot having a perovskite structure (for example, (Cs, FA, MA)(Pb, Sn)(F, Cl, Br, I)₃, where FA and MA represent formamidinium and methylammonium, respectively), a II-VI group quantum dot (for example, CdSe), a III-V group quantum dot (for example, InP), a quantum dot having a chalcopyrite structure (for example, (Ag, Cu)(In, Ga)(S, Se)₂), or the like. The wavelength conversion substance described above is a particle. Further, one type of these wavelength conversion substances can be used alone, or two or more types of these wavelength conversion substances can be used in combination.

The light-emitting unit 330-1 uses a blue LED as the light-emitting element 332, and a white light is emitted by the wavelength conversion member 334 containing a wavelength conversion substance for wavelength-converting the light emitted from the light-emitting element 332 to yellow. As the light reflective substance included in the wavelength conversion member 334, for example, titanium oxide, barium titanate, aluminum oxide, silicon oxide, and the like can be used.

The covering member 335 is a member that covers the lateral surfaces of the light-emitting element 332 and the wavelength conversion member 334. The covering member 335 directly or indirectly covers the lateral surfaces of the light-emitting element 332 and the wavelength conversion member 334. An upper surface of the wavelength conversion member 334 is exposed from the covering member 335 and corresponds to the light-emitting surface 331-1 of the light-emitting unit 330-1. The covering member 335 is preferably constituted by a member having a high light reflectivity in order to improve light extraction efficiency. An organic material such as a resin containing a light reflective substance such as white pigment, for example, can be used as the covering member 335. Alternatively, the covering member 335 may be the light reflective member formed of, for example, inorganic materials including boron nitride and alkali metal silicate. In this case, titanium oxide or zirconium oxide can be further contained.

Examples of the light reflective substance include titanium oxide, zinc oxide, magnesium oxide, magnesium carbonate, magnesium hydroxide, calcium carbonate, calcium hydroxide, calcium silicate, magnesium silicate, barium titanate, barium sulfate, aluminum hydroxide, aluminum oxide, zirconium oxide, and silicon oxide. One type of these is preferably used alone, or a combination of two or more types thereof are preferably used. The resin material is preferably a material in which a resin material including a thermosetting resin, such as an epoxy resin, an epoxy modified resin, a silicone resin, a silicone modified resin, a phenol resin, or the like, as a main component is used as a base material. Note that the covering member 335 may be constituted by a member having light transmissivity or a light absorbing property with respect to visible light as necessary. The member having the light absorbing property includes, for example, carbon black.

The light-emitting unit 330-1 is electrically connected to a wiring 352 included in the substrate 35. The substrate 35 includes the wiring 352 disposed on a surface of the substrate 35. The substrate 35 may include the wiring 352 inside the substrate 35. The light-emitting unit 330-1 and the substrate 35 are electrically connected to each other by connecting the wiring 352 of the substrate 35 and at least the pair of positive and negative electrodes 333 of the light-emitting unit 330-1 to each other via an electrically conductive member 353. The configuration, size, and the like of the wiring 352 of the substrate 35 are set according to the configuration and size of the electrode 333 of the light-emitting unit 330-1.

The wiring 352 can be formed of at least one type of copper, iron, nickel, tungsten, chromium, aluminum, silver, gold, titanium, palladium, rhodium, alloys thereof, or the like. Furthermore, a layer of silver, platinum, aluminum, rhodium, gold, alloys thereof, or the like may be provided on the surface layer of the wiring 352 to increase the wettability and/or light reflectivity of the electrically conductive member 353.

### MODIFIED EXAMPLE

Various modified examples of the image display device according to embodiments will be described below. The same names and symbols as those in the previously described embodiment of the present disclosure indicate the same or similar members or configurations, and detailed explanations thereof are omitted as appropriate. This is the same for the following modified examples. The smartphone 200 illustrated in FIG. 1 can include an image display device according to each of modified examples described below.

### First Modified Example

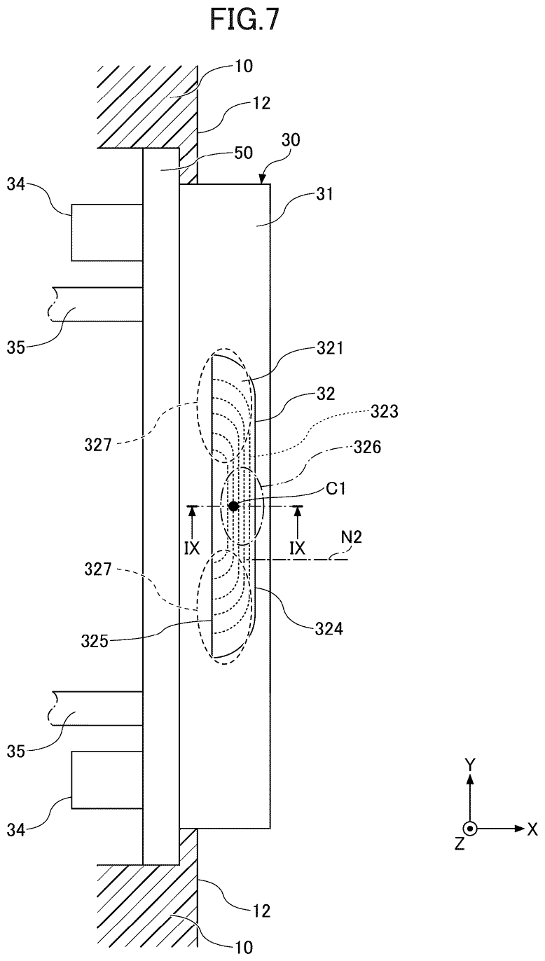

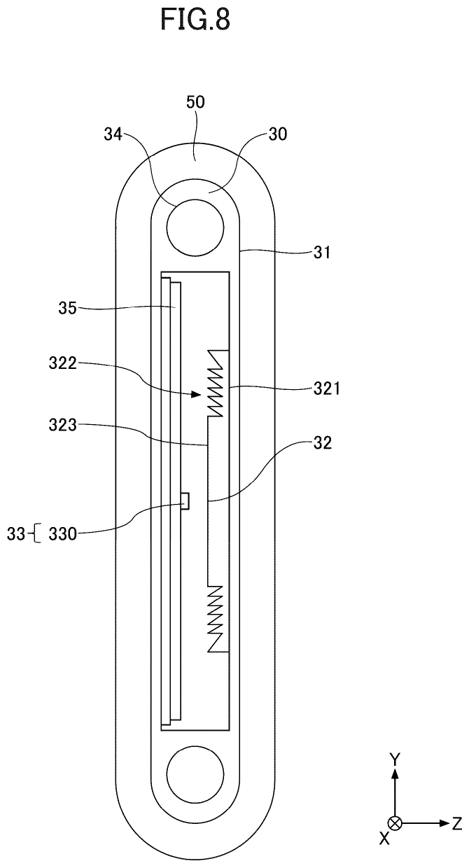

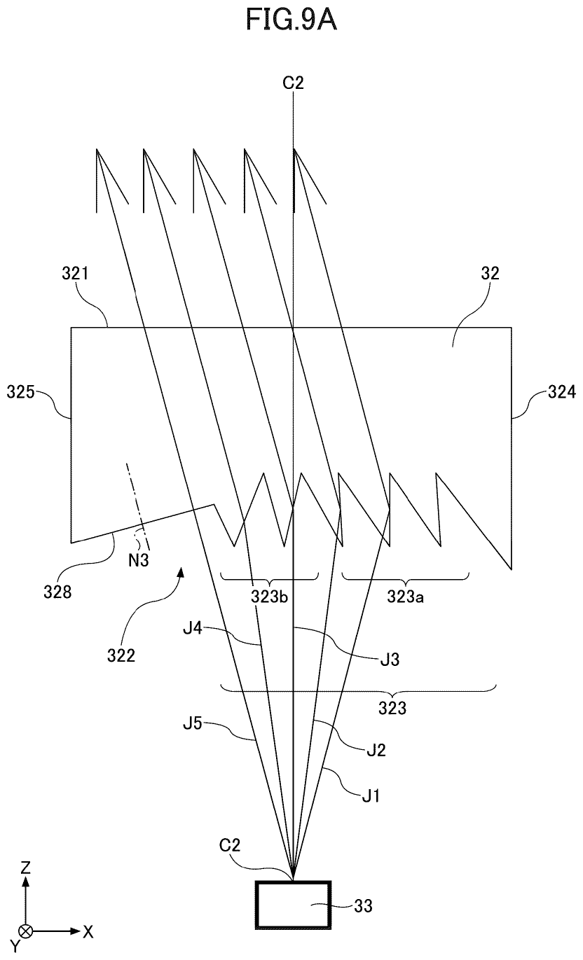

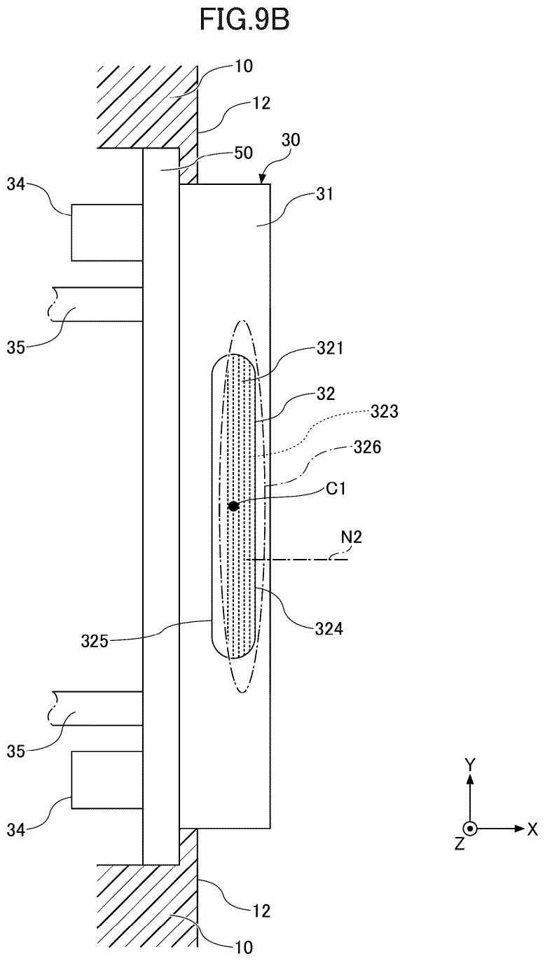

A structure included in an image display device according to an aspect of a first modified example will be described with reference to FIGS. 7 to 9B. FIG. 7 is a schematic view of the structure 30 included in the image display device according to an aspect of the first modified example when viewed facing the display surface 21. FIG. 8 is a schematic view of the structure 30 included in the image display device according to the aspect of the first modified example when viewed from the −X side (in other words viewed from the side where the display unit 20 is located). FIG. 9A is a schematic view of the structure 30 included in the image display device according to the aspect of the first modified example when viewed from the side opposite to the side where the display unit 20 is located. FIG. 9A omits the housing 10. FIG. 9A is a schematic cross-sectional view taken along line IX-IX in FIG. 7 and is a schematic view illustrating a cross section passing through the first lateral portion 324, the second lateral portion 325, and a center C1 of the light-transmissive member 32. FIG. 9B is a schematic view of the structure 30 included in the image display device according to the aspect of the first modified example when viewed facing the display surface. The center C1 is an intersection of a center of the maximum width of the light-transmissive member 32 in the X direction and a center of the maximum length of the light-transmissive member 32 in the Y direction in a top view.

In the present modified example, the configuration of the light-transmissive member 32 is mainly different from that of the first embodiment.

In the present modified example, when viewed facing the display surface 21, the light-transmissive member 32 includes the first lateral portion 324 located in a direction farther from the housing 10 and the second lateral portion 325 located closer to the housing 10 than to the first lateral portion 324. The light-transmissive member 32 includes, on the incident surface(s) 322, the plurality of protrusions 323 each including a first portion 326 along the first lateral portion 324. Each of the plurality of protrusions 323 is arranged in a direction along a normal line N2 of the first lateral portion 324 when viewed facing the display surface 21, and is disposed closer to the first lateral portion 324 than to the second lateral portion 325 in a cross section passing through the first lateral portion 324, the second lateral portion 325, and the center C1 of the light-transmissive member 32 when viewed facing the display surface 21. In the present modified example, as illustrated in FIG. 7, the outer shape of the light-transmissive member 32 in a top view has a shape obtained by dividing a substantially elliptical shape into two in the longitudinal direction.

The light source unit 33 illustrated in FIGS. 7 to 9A includes one light-emitting unit 330. In the present modified example, as illustrated in FIGS. 7 and 9A, the light from the light source unit 33 is guided by the first portion 326 of the plurality of protrusions 323 so as to approach the second lateral portion 325 when viewed facing the display surface 21. The first portion 326 of the plurality of protrusions 323 can impart a deflection action by, for example, a linear Fresnel lens to the light from the light source unit 33 so that the light from the light source unit 33 approaches the second lateral portion 325. Accordingly, in the present modified example, when viewed facing the display surface 21, light emitted in the direction in which the display surface 21 faces is less likely to spread away from the second lateral portion 325 (for example, toward the +X direction). Thus, the light emitted in the direction in which the display surface 21 faces can irradiate the operator who takes a selfie with higher efficiency.

In the present modified example, the protrusion 323 includes the first portion 326 and second portions 327. The second portion 327 is continuous with an end portion of the first portion 326 and extends in a direction from the first lateral portion 324 toward the second lateral portion 325 when viewed facing the display surface 21. In the example illustrated in FIG. 7, the direction from the first lateral portion 324 toward the second lateral portion 325 is the −X direction.

In the present modified example, the protrusion 323 includes the second portion 327 that is continuous with the end portion of the first portion 326 along the first lateral portion 324 and extends in a direction from the first lateral portion 324 toward the second lateral portion 325 when viewed facing the display surface 21. With this configuration, among the light incident on the light-transmissive member 32 from the light source unit 33, for example, the light traveling to the +Y side along the first lateral portion 324 when viewed facing the display surface 21 can be guided to a center side (−Y side) of the display surface 21 by the second portion 327. The light traveling to the −Y side along the first lateral portion 324 can be guided to the center side (+Y side) of the display surface 21 by the second portion 327. As a result, in the present modified example, in the light emitted from the light-transmissive member 32, the light distribution can be controlled such that the light traveling to the +Y side along the first lateral portion 324 is directed to the −Y side, and such that the light traveling to the −Y side along the first lateral portion 324 is directed to the +Y side, each opposite to the center side of the display surface 21, and the irradiation efficiency of the light emitted from the light-transmissive member 32 can be increased.

In the present modified example, as illustrated in FIG. 9A, in one cross section passing through the first lateral portion 324, the second lateral portion 325, and the center C1 of the light-transmissive member 32, the light-transmissive member 32 includes, on the incident surface(s) 322, the plurality of protrusions 323 located on the first lateral portion 324 side and a flat portion 328 adjacent to the plurality of protrusions 323 while being on the second lateral portion 325 side. The plurality of protrusions 323 include one or more first protrusions 323a located on the first lateral portion 324 side with respect to a center C2 of the light source unit 33 and one or more second protrusions 323b located on the second lateral portion 325 side with respect to the center C2 of the light source unit 33 when viewed facing the display surface 21. The first protrusion(s) 323a reflects light emitted from the center C2 of the light source unit 33. The second protrusion(s) 323b refracts light emitted from the center C2 of the light source unit 33. The flat portion 328 transmits the light emitted from the center C2 of the light source unit 33 without refracting the light.

In FIG. 9A, part of the light emitted from the light source unit 33 is indicated by arrows as light beams J1 to J5. In FIG. 9A, the light beam J1 represents one of a plurality of light beams emitted from the center C2 of the light source unit 33 and incident on a surface on the first lateral portion 324 side (+X side) of the protrusion 323 included in the first protrusions 323a. The light beam J2 represents one of the plurality of light beams emitted from the center C2 of the light source unit 33 and incident on a surface on the first lateral portion 324 side (+X side) of the protrusion 323 included in the first protrusions 323a. The light beam J3 represents one of the plurality of light beams emitted from the center C2 of the light source unit 33 and incident on a surface on the first lateral portion 324 side (+X side) of the protrusion 323 included in the second protrusions 323b. The light beam J4 represents one of the plurality of light beams emitted from the center C2 of the light source unit 33 and incident on a surface on the first lateral portion 324 side (+X side) of the protrusion 323 included in the second protrusions 323b. The light beam J5 represents one of the plurality of light beams emitted from the center C2 of the light source unit 33 and incident on the flat portion 328.

In the example illustrated in FIG. 9A, the first protrusion(s) 323a is located on the first lateral portion 324 side with respect to the center C2 of the light source unit 33. Here, “located on the first lateral portion 324 side with respect to the center C2 of the light source unit 33” means that, in a cross section, a tip portion of any protrusion 323 is located on the first lateral portion 324 side with respect to the center C2 of the light source unit 33. The light beam J1 is incident on the surface on the first lateral portion 324 side (+X side) of one protrusion 323 included in the first protrusions 323a from the second lateral portion 325 side (−X side). Similarly, the light beam J2 is incident on the surface on the first lateral portion 324 side (+X side) of one protrusion 323 included in the first protrusions 323a from the second lateral portion 325 side (−X side). The surface on the first lateral portion 324 side (+X side) of each of the protrusions 323 included in the first protrusions 323a can reflect a respective one of the incident light beam J1 and light beam J2 in a desired direction such as the center side (−X side) of the display surface 21.

The second protrusion(s) 323b is located on the second lateral portion 325 side with respect to the center C2 of the light source unit 33. Here, “located on the second lateral portion 325 side with respect to the center C2 of the light source unit 33” means that, in a cross section, a tip portion of any protrusion 323 is located on the second lateral portion 325 side with respect to the center C2 of the light source unit 33. The light beam J3 is incident on the surface on the first lateral portion 324 side (+X side) of one protrusion 323 included in the second protrusions 323b from the first lateral portion 324 side (+X side). Similarly, the light beam J4 is incident on the surface on the first lateral portion 324 side (+X side) of the protrusion 323 included in the second protrusions 323b from the first lateral portion 324 side (+X side). The surface on the first lateral portion 324 side (+X side) of each of the protrusions 323 included in the second protrusions 323b can refract a respective one of the incident light beam J3 and light beam J4 in a desired direction such as the center side (−X side) of the display surface 21.

A surface of the flat portion 328 is inclined such that a normal line N3 of the flat portion 328 extends toward the center side (−X side) of the display surface 21 as extending toward the +Z side. The light beam J5 is incident substantially perpendicularly to the surface of the flat portion 328. The surface of the flat portion 328 transmits the incident light beam J5 substantially without refracting it. Accordingly, the light beam J5 incident on the surface of the flat portion 328 can travel substantially straight in a desired direction such as the center side of the display surface 21.

Here, the plurality of light beams emitted from the center C2 of the light source unit 33 may be incident on different positions of the incident surface(s) 322 of the light-transmissive member 32. Optical actions of deflecting the light incident on the incident surface 322 toward the center side of the display surface 21 include an action of reflecting the incident light, an action of refracting the incident light, and the like. When the same deflection action is intended to be imparted to the light incident on the incident surface(s) 322 regardless of the position of the light with respect to the center C2 of the light source unit 33, there is a possibility that the light incident on the incident surface(s) 322 is difficult to deflect in a desired direction. For example, in refraction, because the refraction angle has a limitation according to Snell's law, when the refraction angle exceeds the limitation, the light-transmissive member 32 cannot deflect the incident light in the desired direction. Thus, when the deflection action by refraction is intended to be similarly imparted to the light emitted from the center C2 of the light source unit 33 and incident on the incident surface(s) 322 regardless of the position of the light with respect to the center C2 of the light source unit 33, it may be difficult to design the light-transmissive member 32 for guiding the incident light in a desired direction. When it is difficult to design the light-transmissive member 32, there is a case in which the light incident on the light-transmissive member 32 cannot be guided in the desired direction. Furthermore, when the plurality of projections 323 are provided on the entire surface of the incident surface(s) 322, there is a case in which the light cannot be guided in the desired direction due to the presence of the projections 323 in a region where the light is incident substantially perpendicularly to the surface. As a result of the fact that the light cannot be guided in the desired direction, there is a possibility that a variation of the number of incident light beams per unit area of light radiated from the image display device in the direction in which the display surface 21 faces occurs and illuminance variation occurs on an irradiated surface.

In the present modified example, in the light-transmissive member 32, the light emitted from the center of the light source unit 33 and incident on the incident surface(s) 322 is reflected at the second protrusion(s) 323a and refracted at the first protrusion(s) 323b depending on the position of the light with respect to the center C2 of the light source unit 33. Accordingly, the light-transmissive member 32 can deflect the light incident on the incident surface(s) 322 in the desired direction such as toward the center side of the display surface 21. In the light-transmissive member 32, the light emitted from the center of the light source unit 33 can travel substantially straight by the flat portion 328 in the region where the light is incident substantially perpendicularly to the surface on the second lateral portion 325 side. Accordingly, the light-transmissive member 32 can guide the light incident on the incident surface(s) 322 in a desired direction. As a result, in the present modified example, the variation of the number of incident light beams per unit area of light radiated from the image display device in the direction in which the display surface 21 faces can be reduced and illuminance variation can be reduced on the irradiated surface.

As illustrated in FIG. 9B, the light-transmissive member 32 may be configured such that all of the plurality of protrusions 323 are the first portion 326 extending in the direction along the first lateral portion 324. Accordingly, part of the light incident on the light-transmissive member 32 from the light source unit 33 is guided to the +Y side along the first lateral portion 324 when viewed facing the display surface 21. Thus, when viewed facing the display surface 21, the light spreads to the +Y side along the first lateral portion 324, and thus the operator taking a selfie can be illuminated at a wide radiation angle.

### Second Modified Example

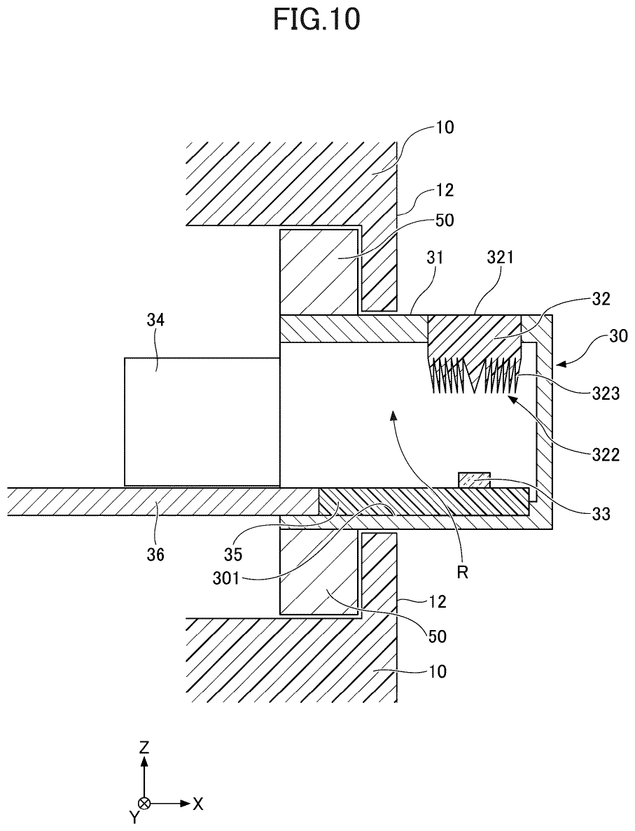

A structure included in an image display device according to a second modified example will be described with reference to FIG. 10. FIG. 10 is a schematic cross-sectional view of the structure 30 included in the image display device according to the second modified example.

The present modified example is mainly different from the above-described first embodiment in that the substrate 35 and the structure 30 are monolithic.

In the example illustrated in FIG. 10, inside the structure 30 including the space R, the substrate 35 is formed monolithically with the structure 30 without using the adhesive member 37 so as to constitute part of the inner surface 301. For example, when the structure 30 is formed of a resin material by using a mold, the substrate 35 is disposed in the mold, the mold is closed, the resin material is injected into the mold, the resin material is cured, and the mold is opened. Accordingly, a configuration in which the structure 30 is monolithic with the substrate 35 can be obtained. With this configuration, a step of bonding the substrate 35 to the inner surface 301 of the structure 30 with the adhesive member 37 in the first embodiment described above is not necessary, and thus the image display device can be easily manufactured in the present modified example.

### Third Modified Example

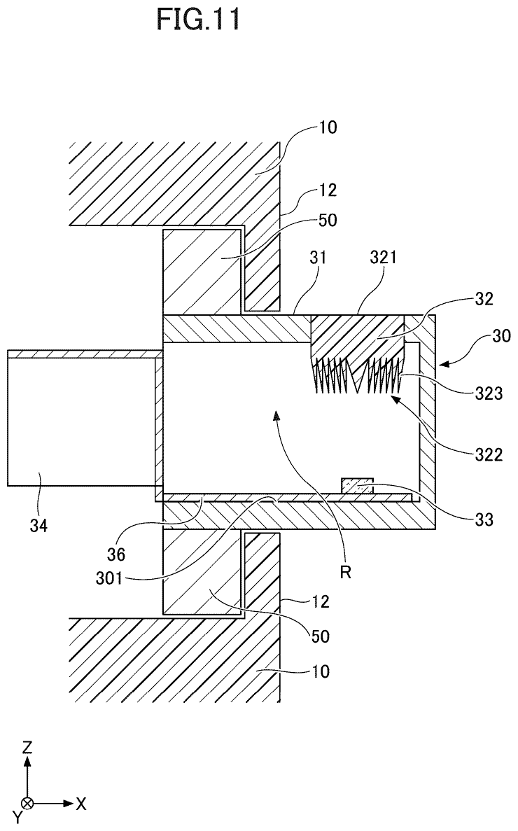

A structure included in an image display device according to a third modified example will be described with reference to FIG. 11. FIG. 11 is a schematic cross-sectional view of the structure 30 included in the image display device according to the third modified example.

The present modified example is mainly different from the above-described first embodiment in that the wiring 36 is provided in the structure 30.

In the example illustrated in FIG. 11, the wiring 36 is provided on at least part of the inner surface 301 of the structure 30 including the space R. The light source unit 33 is mounted on the wiring 36 provided on the inner surface 301 of the structure 30. With this configuration, the step of bonding the substrate 35 to the inner surface 301 of the structure 30 with the adhesive member 37 in the first embodiment described above is not necessary, and thus the image display device can be easily manufactured in the present modified example.

### Fourth Modified Example

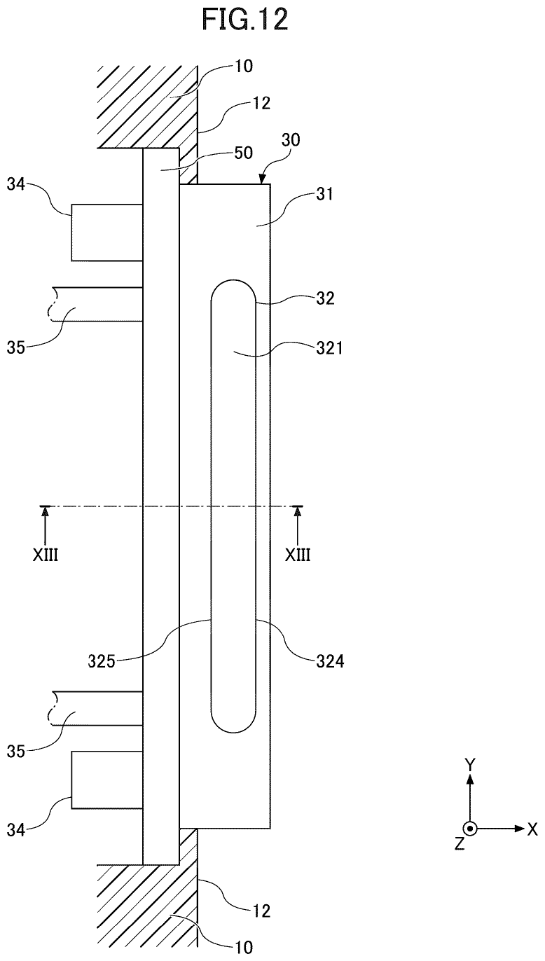

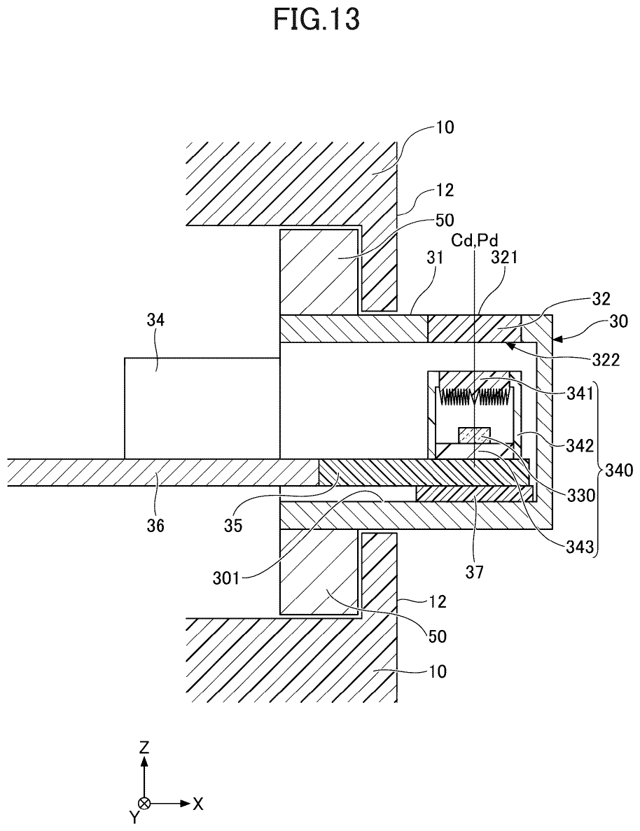

A structure included in an image display device according to a fourth modified example will be described with reference to FIGS. 12 and 13. FIG. 12 is a schematic view of the structure 30 included in the image display device according to the fourth modified example when viewed facing the display surface 21. FIG. 13 is a schematic cross-sectional view taken along line XIII-XIII in FIG. 12.

In the present modified example, the light source unit 33 includes a light-emitting module 340. The light-emitting module 340 includes a light-emitting unit 330, a lens 341 located above the light-emitting unit 330, and a light-shielding member 342 that supports the lens 341. A lateral surface of the light-emitting unit 330 is covered with the light-shielding member 342. In the present modified example, the above points are mainly different from the first embodiment described above.

In the light-emitting module 340, an optical axis Cd of the lens 341 and a center Pd of the light-emitting unit 330 overlap each other in a top view. In the present modified example, the light source unit 33 includes the light-emitting module 340 including the lens 341 and the light-emitting unit 330 aligned with the lens 341, and thus the image display device can be easily manufactured.

The light source unit 33 illustrated in FIGS. 12 and 13 includes a light-emitting module 340-1, a light-emitting module 340-2, and a light-emitting module 340-3 as a plurality of the light-emitting modules 340. The light-emitting module 340-1, the light-emitting module 340-2, and the light-emitting module 340-3 are arranged side by side in the direction along first lateral portion 324. The light-emitting module 340-1, the light-emitting module 340-2, and the light-emitting module 340-3 have substantially the same configuration. In the following description, the light-emitting module 340-1, the light-emitting module 340-2, and the light-emitting module 340-3 may be collectively referred to as the light-emitting module 340. The light-emitting module 340-1, the light-emitting module 340-2, and the light-emitting module 340-3 may be different from each other in at least part of the configuration.

The light-emitting module 340 illustrated in FIGS. 12 and 13 is disposed inside the structure 30 and is disposed on the substrate 35 bonded to the inner surface 301 of the structure 30 with the adhesive member 37. The light-emitting module 340 illustrated in FIGS. 12 and 13 further includes a mounting member 343 on which the light-emitting unit 330 is mounted. The light-emitting module 340 is disposed on the substrate 35 such that a lower surface of the mounting member 343 faces an upper surface of the substrate 35. However, the light-emitting module 340 does not have to include the mounting member 343, and the light-emitting unit 330 may be directly disposed on the substrate 35.

In the example illustrated in FIGS. 12 and 13, the light-transmissive member 32 is disposed above the light-emitting module 340 disposed on the substrate 35. The emission surface 321 of the light-transmissive member 32 partially constitutes the light-emitting surface 31. The light-transmissive member 32 illustrated in FIGS. 12 and 13 is a parallel plate in which each of the emission surface 321 and the incident surface(s) 322 is a substantially flat surface, and the emission surface 321 and the incident surface(s) 322 are substantially parallel to each other. Light-transmissive member 32 transmits light from each of the plurality of light-emitting modules 340.

The light-transmissive member 32 illustrated in FIGS. 12 and 13 includes the first lateral portion 324 and the second lateral portion 325 that is parallel to and equal in length to the first lateral portion 324. In a top view (when viewed facing the display surface 21), the outer shape of the light-transmissive member 32 is a shape whose longitudinal direction is the direction along the first lateral portion 324. In a top view, both ends of the first lateral portion 324 and the second lateral portion 325 have an arc-shaped curve connecting one first lateral portion 324 and one second lateral portion 325 to each other and an arc-shaped curve connecting the other first lateral portion 324 and the other second lateral portion 325 to each other, respectively. The light-transmissive member 32 has a shape whose longitudinal direction is the direction along the first lateral portion 324 when viewed facing the display surface 21. Thus, the light-transmissive member 32 can transmit light from the light source unit 33 including the plurality of light-emitting modules 340 disposed in the direction along the first lateral portion 324 and emit the light in the direction in which the display surface 21 faces. The light-transmissive member 32 having curves at both ends of the first lateral portion 324 and the second lateral portion 325 when viewed facing the display surface 21 can reduce vignetting of light from the light source unit 33, and efficiently transmit the light from the light source unit 33. However, the shape of the light-transmissive member 32 when viewed facing the display surface 21 is not limited to that described above, and can be appropriately changed according to the shape of the structure 30 or the like.

The lens 341 illustrated in FIG. 13 is a Fresnel lens including a plurality of protrusions each having a concentric circular shape or a concentric elliptical shape on the incident surface side. However, the lens 341 is not limited to the Fresnel lens, and may be a biconvex single lens, a planoconvex single lens, a biconcave single lens, a planoconcave single lens, an array lens, a meniscus single lens, an aspherical lens, or a cylindrical lens.

### Fifth Modified Example

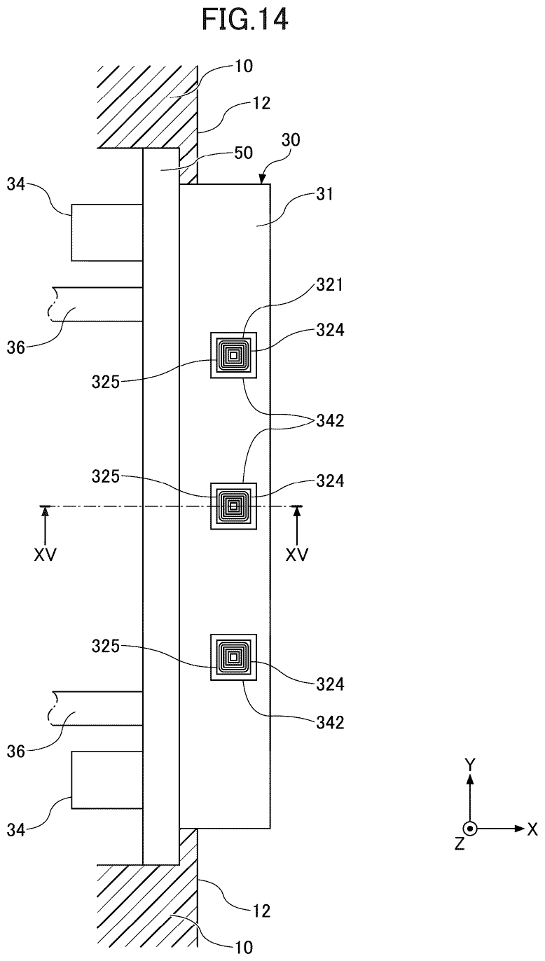

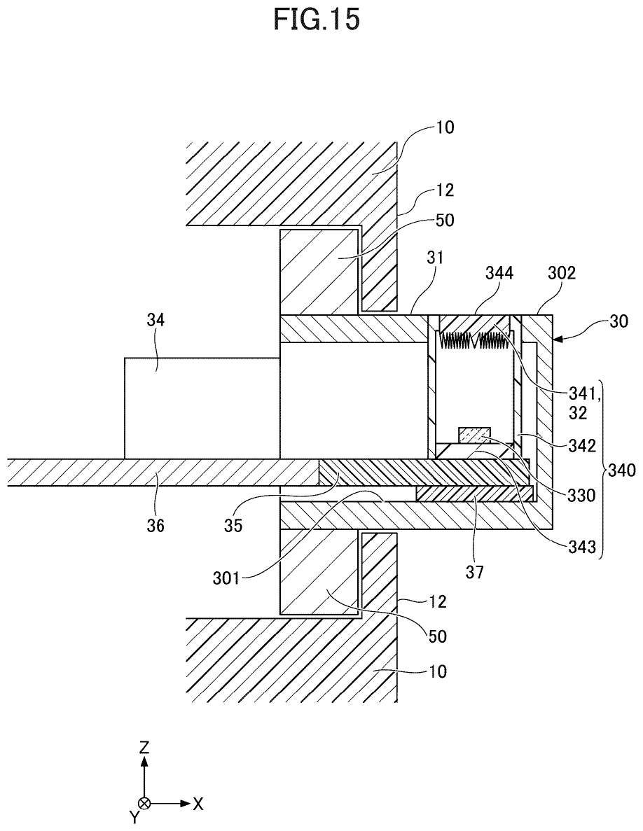

A structure included in an image display device according to a fifth modified example will be described with reference to FIGS. 14 and 15. FIG. 14 is a schematic view of the structure 30 included in the image display device according to the fifth modified example when viewed facing the display surface 21. FIG. 15 is a schematic cross-sectional view taken along line XV-XV in FIG. 14.

The present modified example is mainly different from the above-described fourth modified example in that an emission surface 344 of lens 341 included in the light-emitting module 340 partially constitutes the light-emitting surface 31. Also in the present modified example, the same effect as that of the fourth modified example described above can be obtained.

The light source unit 33 illustrated in FIGS. 14 and 15 includes a light-emitting module 340-1, a light-emitting module 340-2, and a light-emitting module 340-3 as the plurality of light-emitting modules 340. The light-emitting module 340-1, the light-emitting module 340-2, and the light-emitting module 340-3 are arranged side by side in the direction along first lateral portion 324. In the present modified example, the light-emitting module 340-1, the light-emitting module 340-2, and the light-emitting module 340-3 have substantially the same configuration. The light-emitting module 340-1, the light-emitting module 340-2, and the light-emitting module 340-3 may be different from each other in at least part of the configuration.

In the present modified example, part of the light-emitting module 340 is disposed near the light-transmissive member 32 partially constituting the light-emitting surface 31 of the structure 30. Specifically, as illustrated in FIG. 15, the emission surface 344 of the lens 341 included in the light-emitting module 340 and part of the light-shielding member 342 supporting the lens 341 partially constitute the light-emitting surface 31. That is, in the present modified example, the light-transmissive member 32 is the lens 341, and the lens 341 is disposed at an inner side of a through hole of the structure 30 when viewed facing the display surface 21. The light emitted from the light-emitting unit 330 transmits through the lens 341 and is emitted in the direction in which the display surface 21 faces.

The light-emitting module 340 is disposed not only at the inner side of the through hole of the structure 30 but also inside the structure 30 and is disposed on the substrate 35 bonded to the inner surface 301 of the structure 30 with the adhesive member 37. The light-emitting module 340 illustrated in FIGS. 14 and 15 further includes the mounting member 343 on which the light-emitting unit 330 is mounted. The light-emitting module 340 is disposed on the substrate 35 such that a lower surface of the mounting member 343 faces an upper surface of the substrate 35. In the present embodiment, the mounting member 343 includes wiring for electrically connecting the light-emitting unit 330 and the wiring 352 included in the substrate 35 to each other. However, the mounting member 343 does not have to include the wiring. The light-emitting module 340 does not have to include the mounting member 343, and the light-emitting unit 330 may be directly disposed on the substrate 35.

An upper surface of the light-shielding member 342 of the present embodiment is flush with the outer surface 302 (light-emitting surface 31) of the structure 30, that is, is part of the light-emitting surface 31. Thus, the light-shielding member 342 and the outer surface 302 of the structure 30 preferably have substantially the same color. When the light-shielding member 342 and the outer surface 302 (particularly, the light-emitting surface 31) of the structure 30 have substantially the same color, the structure 30 has a good appearance when viewed from the outside. For example, when the light-emitting surface 31 of the structure 30 is white, the light-shielding member 342 is a resin or the like containing a light reflective substance such as a white pigment. For example, when the light-emitting surface 31 of the structure 30 is black, the light-shielding member 342 is a resin or the like containing a light absorbing substance. The color of the light-shielding member 342 is not limited to the above, and the color of the light-shielding member 342 and the color of the outer surface 302 of the structure 30 may be different from each other.

The three light-transmissive members 32 (in other words, the lenses 341) illustrated in FIGS. 14 and 15 include three first lateral portions 324 and three second lateral portions 325 that are parallel to and equal in length to each other and correspond to the three first lateral portions 324, respectively. In a top view (when viewed facing the display surface 21), the outer shape of the light-transmissive member 32 is, for example, a square shape. When viewed facing the display surface 21, the light-transmissive member 32 can transmit the light from the light source unit 33 including the plurality of light-emitting modules 340 and emit the light in the direction in which the display surface 21 faces. However, the shape of the light-transmissive member 32 when viewed facing the display surface 21 is not limited to that described above, and can be appropriately changed depending on the shape of the structure 30 or the like.

### Sixth Modified Example

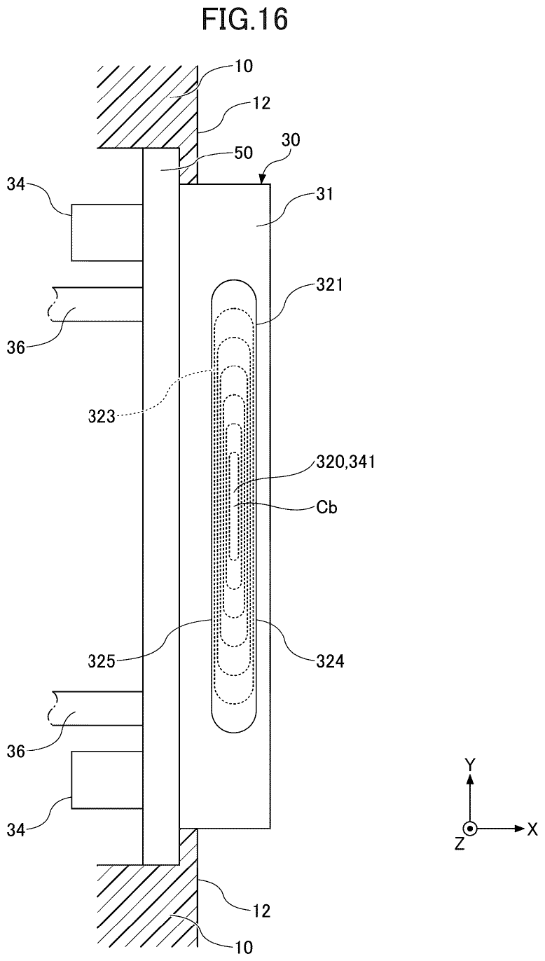

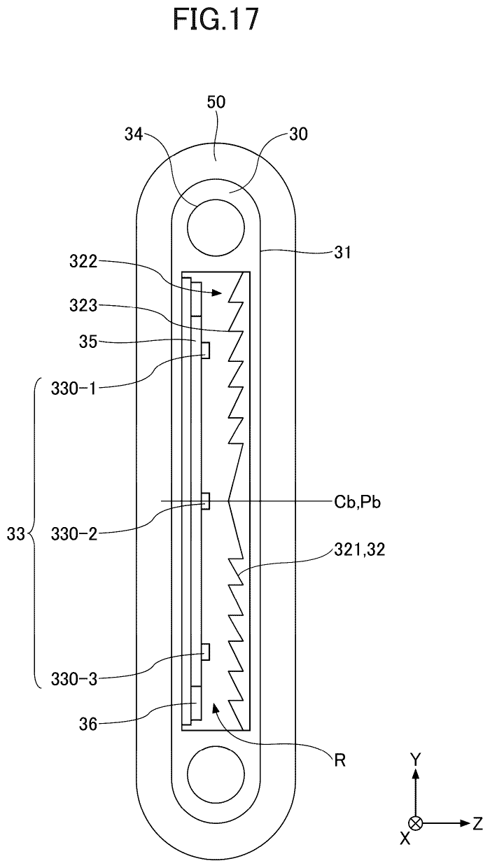

A structure included in an image display device according to a sixth modified example will be described with reference to FIGS. 16 and 17. FIG. 16 is a schematic view of the structure 30 included in the image display device according to the sixth modified example when viewed facing the display surface 21. FIG. 17 is a schematic view of the structure 30 included in the image display device according to the sixth modified example when viewed from the −X side (in other words viewed from the side where the display unit 20 is located).

The present modified example is mainly different from the above-described first embodiment in that the light source unit 33 includes the plurality of light-emitting units and the lens 341 includes one lens unit 320 corresponding to collective of the plurality of light-emitting units. The light source unit 33 includes the light-emitting unit 330-1, the light-emitting unit 330-2, and the light-emitting unit 330-3 as the plurality of light-emitting units.

In the example illustrated in FIGS. 16 and 17, the light-emitting unit 330-1, the light-emitting unit 330-2, and the light-emitting unit 330-3 included in the light source unit 33 are arranged side by side in the direction along the first lateral portion 324. The one lens unit 320 included in the lens 341 corresponds to the plurality of light-emitting units (the light-emitting unit 330-1, the light-emitting unit 330-2, and the light-emitting unit 330-3). Each of the light-emitting unit 330-1, the light-emitting unit 330-2, and the light-emitting unit 330-3 is disposed to face the one lens unit 320. Also in the present modified example, the same effect as that of the first embodiment described above can be obtained. Because the plurality of light-emitting units are disposed for the one lens unit, an amount of light emitted from the one lens unit can be increased.

While preferred embodiments have been described in detail above, the disclosure is not limited to the above-described embodiments, various modifications and substitutions can be made to the above-described embodiments without departing from the scope described in the claims.

The ordinal numbers, quantity, and the like used in the description of the embodiments all are exemplified to specifically describe the technology of the present disclosure, and the present disclosure is not limited to the numbers exemplified. In addition, the connection relationship between the components is exemplified for specifically describing the technique of the present disclosure, and the connection relationship for realizing the function of the present disclosure is not limited thereto.

Because the light source unit can be disposed in an existing portion, the image display device of the present disclosure can be suitably used for an information terminal such as a smartphone, a tablet, or a laptop personal computer (PC). However, the image display device of the present disclosure is not limited to these uses.

What is claimed is:

1. An image display device comprising:
a housing including an inner surface defining an opening, and an outer surface located on a side opposite to the inner surface;
a display unit including a display surface and disposed in the opening and; and
a structure including a light-emitting surface, the structure at least partially protruding from the outer surface when viewed facing the display surface, wherein the structure comprises:
a light-transmissive member including an emission surface and an incident surface, the emission surface at least partially constituting the light-emitting surface, and
a light source unit that is configured to emit light to the incident surface of the light-transmissive member and through the light-transmissive member in a direction in which the display surface faces.

2. The image display device according to claim 1, wherein the image display device comprises an operation button that comprises the structure.

3. The image display device according to claim 1, wherein the light-transmissive member is a lens.

4. The image display device according to claim 3, wherein the lens comprises a plurality of protrusions each having a concentric circular shape or a concentric elliptical shape on an incident surface side.

5. The image display device according to claim 3, wherein:
the light-transmissive member includes, when viewed facing the display surface:
a first lateral portion, and
a second lateral portion located closer to the housing than to the first lateral portion,
the light-transmissive member comprises a plurality of protrusions each including a first portion along the first lateral portion on the incident surface, and
each of the plurality of protrusions is arranged in a direction along a normal line of the first lateral portion when viewed facing the display surface, and is arranged closer to the first lateral portion than to the second lateral portion in a cross section passing through the first lateral portion, the second lateral portion, and a center of the light-transmissive member when viewed facing the display surface.

6. The image display device according to claim 5, wherein at least one of the plurality of protrusions of the light-transmissive member further comprises a second portion that is continuous with an end portion of the first portion and extends in a direction from the first lateral portion toward the second lateral portion when viewed facing the display surface.

7. The image display device according to claim 5, wherein:
the plurality of protrusions of the light-transmissive member comprise:
one or more first protrusions located closer to the first lateral portion with respect to a center of the light source unit when viewed facing the display surface, and
one or more second protrusions located closer to the second lateral portion with respect to the center of the light source unit when viewed facing the display surface,
the light-transmissive member comprises, on the incident surface, a flat portion adjacent to the one or more second protrusions on a second lateral portion side in the cross section,
the one or more first protrusions are configured to reflect light emitted from the center of the light source unit,
the one or more second protrusions are configured to refract the light emitted from the center of the light source unit, and
the flat portion is configured to transmit the light emitted from the center of the light source unit without refracting the light.

8. The image display device according to claim 3, wherein:
the light source unit comprises a plurality of light-emitting units, and
the lens comprises a plurality of lens units respectively corresponding to the plurality of light-emitting units.

9. The image display device according to claim 3, wherein:
the light source unit comprises a plurality of light-emitting units, and
the lens comprises one lens unit collectively corresponding to the plurality of light-emitting units.

10. The image display device according to claim 1, wherein:
the light source unit comprises a light-emitting unit that comprises:
a light-emitting element,
a wavelength conversion member above the light-emitting element, and
a covering member covering a lateral surface of the light-emitting element and a lateral surface of the wavelength conversion member.

11. The image display device according to claim 1, wherein:
the light source unit comprises a light-emitting module that comprises:
a light-emitting unit,
a lens located above the light-emitting unit, and
a light-shielding member supporting the lens, and
a lateral surface of the light-emitting unit is covered with the light-shielding member.

12. A smartphone comprising:
the image display device according to claim 1.
